(19) United States
(12) Patent Application Publication
(10) Pub. No.: US 2009/0286152 A1
(43) Pub. Date: Nov. 19, 2009

(54) ELECTRICITY STORAGE DEVICE

(76) Inventors: Hajime NISHINO, Nara (JP); Kohei SUZUKI, Osaka (JP)

Correspondence Address: MCDERMOTT WILL & EMERY LLP, 600 13TH STREET, NW, WASHINGTON, DC, 20005-3096, US

(21) Appl. No.: 12/467,723

(22) Filed: May 18, 2009

(30) Foreign Application Priority Data
May 19, 2008 (JP) 2008-131136
May 19, 2008 (JP) 2008-131137
Apr. 28, 2009 (JP) 2009-108866

(51) Int. Cl. H01M 2/02; H01M 2/30

(52) U.S. Cl. 429/178; 429/163

(57) ABSTRACT

In an electricity storage device buried with a storage battery accommodated in a housing, it is aimed to prevent a positive electrode terminal and a negative electrode terminal from being corroded even upon condensation in the housing.

An electricity storage device of the present invention is provided with a storage battery 4 including a positive electrode terminal 7 and a negative electrode terminal 8 and a housing 5 for accommodating this storage battery 4 and is so constructed as to satisfy at least one of a first condition of maintaining the potential of the negative electrode terminal 8 lower than a ground surface potential and a second condition of maintaining the potential of the positive electrode terminal 7 higher than the ground surface potential. Alternatively, at least one of the positive electrode terminal 7 and the negative electrode terminal 8 is arranged to face downward.

### BACKGROUND OF THE INVENTION

1. Field of the Invention

The present invention relates to an electricity storage device used by being buried in the ground or the like.

2. Description of the Background Art

With an increasing momentum to suppress the exhaust of carbon dioxide, there have been proposed efficient energy consumption methods by electricity storage. A first method is the one for storing electric power in the nighttime when power use is relatively small and the stored electric power is supplied in the daytime while power generation at power plants is leveled. A second method is the one for temporarily storing electric energy generated based on natural energy such as solar light and wind power and the stored electric power is supplied according to needs. It is necessary to install independent electricity storage systems in buildings and houses in order to broadly use these methods.

Lithium secondary batteries with high energy densities, nickel-hydrogen storage batteries, nickel-cadmium storage batteries, lead storage batteries can be cited as storage batteries used in the electricity storage systems. Since a material with a relatively high specific gravity is used in any of these storage batteries, it is more preferable to bury these storage batteries in the ground or utilizing elevations such as shrubberies and entrance halls than to install them on the roofs of buildings and houses.

Japanese Unexamined Patent Publication No. 2001-211556 discloses an electricity storage system characterized in that heat generated by heat generation of a storage battery is allowed to efficiently escape by burying the storage battery accommodated in a housing in the ground having a large heat capacity.

In the case of burying the housing accommodating the storage battery as in Japanese Unexamined Patent Publication No. 2001-211556, there is a clearance in the housing since the inner volume of the housing is larger than the volume of the storage battery. Moisture sealed in this clearance is cooled by the inner wall of the housing to condense after being warmed by the surface of the heat generating storage battery particularly in winter. If the condensed water drops deposit on a positive electrode terminal and a negative electrode terminal of the storage battery, the terminals are corroded depending on conditions, thereby reducing functions as the storage battery.

### SUMMARY OF THE INVENTION

In order to solve the above problem, an object of the present invention is to prevent the corrosion of positive and negative electrode terminals even upon the occurrence of condensation due to heat generation of a storage battery in an electricity storage device whose housing accommodating the storage battery is buried.

In order to solve the above problem, one aspect of the present invention is directed to an electricity storage device, comprising a storage battery including a positive electrode terminal and a negative electrode terminal; and a housing which accommodates the storage battery and can be buried in the ground, wherein at least one of the positive electrode terminal and the negative electrode terminal is arranged to face downward.

Another aspect of the present invention is directed to an electricity storage device, comprising a storage battery having a positive electrode terminal and a negative electrode terminal; and a housing which accommodates the storage battery and can be buried in the ground, wherein at least one of a first condition of maintaining the potential of the negative electrode terminal lower than a reference ground surface potential and a second condition of maintaining the potential of the positive electrode terminal higher than the reference ground surface potential is satisfied.

According to the present invention, in an electricity storage device buried with a storage battery accommodated in a housing, a positive electrode terminal and a positive electrode terminal can be prevented from being corroded even upon condensation due to heat generation of the storage battery.

### BRIEF DESCRIPTION OF THE DRAWINGS

FIG. 1 is a diagram schematically showing the entire construction of an electricity storage system according to the invention,

FIG. 2 is a side view in section showing an electricity storage device according to a first embodiment,

FIG. 3 is a perspective view schematically showing a storage battery of FIG. 2 in an exploded manner,

FIG. 4 is a side view in section showing a used state of the storage battery,

FIG. 5 is a side view in section showing a used state of the storage battery,

FIG. 6 is a schematic side view showing the burial depth of a housing,

FIG. 7 is a schematic diagram showing a modification of the electricity storage device according to the first embodiment,

FIG. 8 is a schematic diagram showing another modification of the electricity storage device according to the first embodiment,

FIG. 9 is a side view in section showing an electricity storage device according to a second embodiment,

FIG. 10 is a schematic diagram showing a modification of the electricity storage device according to the second embodiment,

FIG. 11 is a schematic diagram showing another modification of the electricity storage device according to the second embodiment,

FIG. 12 is a side view in section showing an electricity storage device according to a third embodiment,

FIG. 13 is a perspective view, partly cut away, showing an electricity storage device according to a fourth embodiment,

FIG. 14 is an exploded perspective view of the electricity storage device of FIG. 13,

FIG. 15 is a section schematically showing a storage battery suitably usable in the electricity storage device of FIG. 13,

FIG. 16 is a perspective view showing a modification of the storage battery of FIG. 13,

FIG. 17 is a perspective view enlargedly showing a storage battery of an electricity storage device according to a fifth embodiment,

FIG. 18 is a perspective view showing a state where an enclosing member is mounted on the storage battery of FIG. 17,

FIG. 19 is a perspective view showing a modification of the storage battery according to the fifth embodiment,

FIG. 20 is a perspective view showing a state where an enclosing member is mounted on the storage battery of FIG. 19,

FIG. 21 is a side view enlargedly showing a storage battery of an electricity storage device according to a sixth embodiment,

FIG. 22 is a side view showing a modification of the electricity storage device according to the sixth embodiment,

FIG. 23 is a side view showing a modification of the storage battery of the electricity storage device according to the sixth embodiment,

FIG. 24 is a perspective view showing a modification of the electricity storage device according to the sixth embodiment,

FIG. 25 is a perspective view showing a state where an enclosing member is mounted on a storage battery of FIG. 24,

FIG. 26 is a perspective view showing a modification of the sixth embodiment,

FIG. 27 is a perspective view showing a state where an enclosing member of FIG. 26 is mounted,

FIG. 28 is an exploded perspective view, partly cut away, showing a part of an electricity storage device according to a seventh embodiment,

FIG. 29 is a diagrammatic section showing a specific construction of a separation layer shown in FIG. 3,

FIG. 30 is a diagrammatic section showing another specific construction of the separation layer shown in FIG. 3,

FIG. 31 is a diagrammatic section showing still another specific construction of the separation layer shown in FIG. 3, and

FIG. 32 is a partial diagrammatic section showing a modification of the housing in each embodiment.

### DETAILED DESCRIPTION OF THE PREFERRED EMBODIMENTS OF THE INVENTION

Hereinafter, best modes for embodying the present invention are described with reference to the drawings.

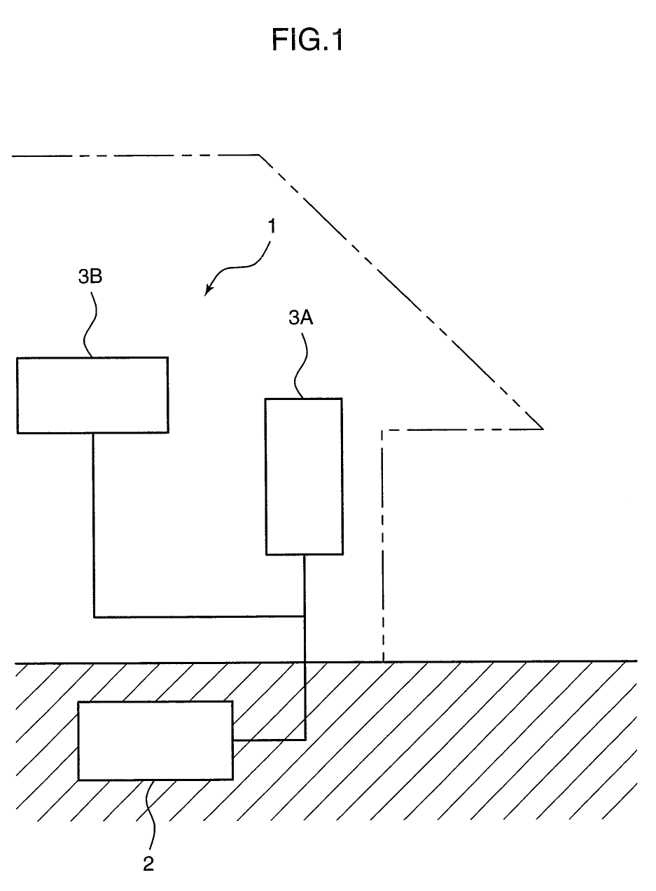

FIG. 1 is a diagram schematically showing the entire construction of an electricity storage system including an electricity storage device according to one embodiment of the present invention.

With reference to FIG. 1, an electricity storage system 1 is provided with an electricity storage device 2 and household electric appliances 3A, 3B electrically connected with this electricity storage device 2, and constructed such that electric power stored in the electricity storage device 2 is appropriately used for the household electric appliances 3A, 3B.

The electricity storage device 2 is used by being buried in the ground and constructed to store electric power generated late night at a power plant, privately generated electric power or the like and supply the thus stored electric power to the household electric appliances 3A, 3B.

Hereinafter, embodiments of the electricity storage device 2 are described.

### First Embodiment

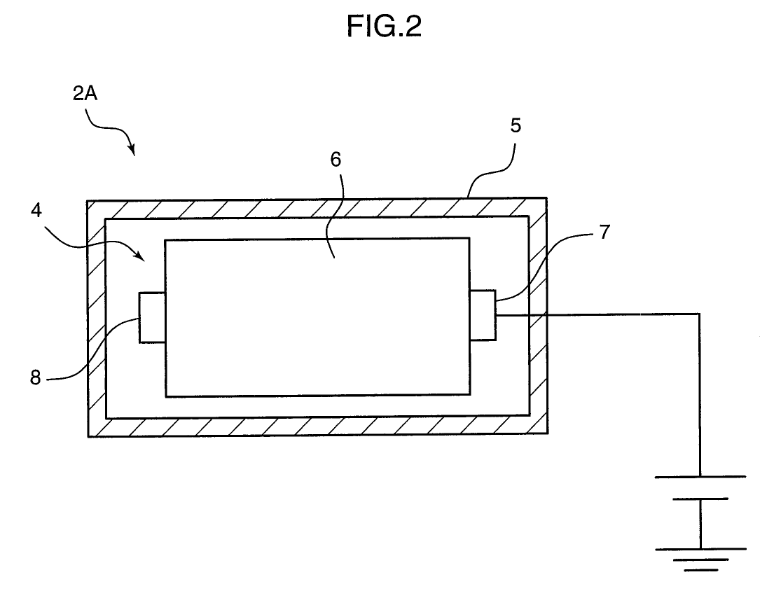

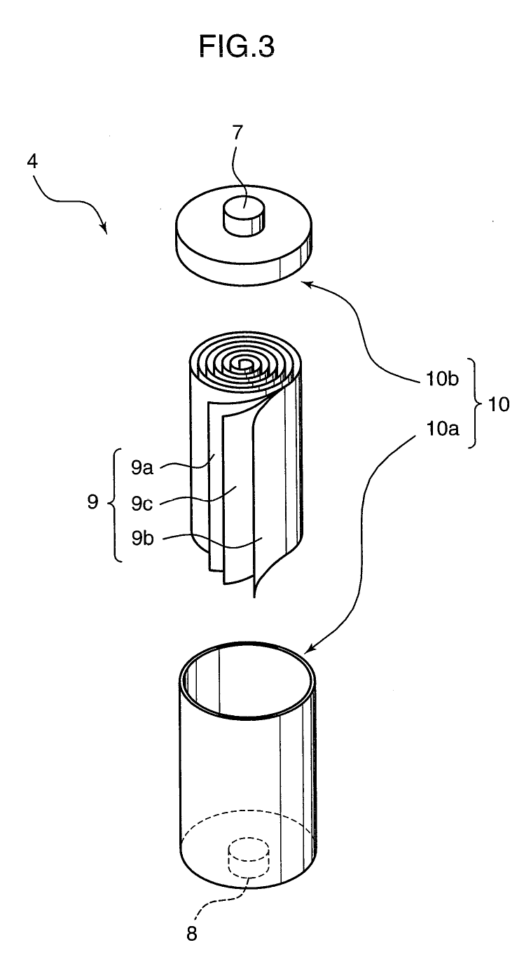

FIG. 2 is a side view in section showing an electricity storage device 2A according to a first embodiment, and FIG. 3 is a perspective view schematically showing a storage battery 4 of FIG. 2 in an exploded manner.

With reference to FIGS. 2 and 3, the electricity storage device 2A is provided with a storage battery 4 and a housing 5 to be buried while accommodating this storage battery 4.

The storage battery 4 includes a battery main body 6 and positive and negative electrode terminals 7, 8 projecting from the opposite longitudinal end surfaces of the battery main body 6.

The battery main body includes a power generating element 9 and a casing 10 for accommodating this power generating element 9. The power generating element 9 is comprised of a positive electrode 9a, a negative electrode 9b and a separation layer 9c interposed between these positive and negative electrodes 9a, 9b, wherein these electrodes and layer are wound. The casing 10 is comprised of a cylindrical bottomed can 10a having a bottom and a sealing plate 10b for sealing this bottomed can 10a. The storage battery 4 is formed by inserting the power generating element 9 and an electrolyte (not shown) into the bottomed can 10a and sealing an opening of this bottomed can 10a by the sealing plate 10b.

The positive electrode terminal 7 is formed to project from the upper surface of the sealing plate 10b. Similarly, the negative electrode terminal 8 is formed to project from the bottom surface of the bottomed can 10a.

The electricity storage device 2A thus constructed is used in a buried state in the ground. Here, the “buried state in the ground” includes not only a state where the upper surface of the housing 5 is located below the ground surface as shown in FIG. 1, but also a state where an upper part of the housing 5 projects from the ground surface and a state where the upper surface of the housing 5 is located on the ground surface.

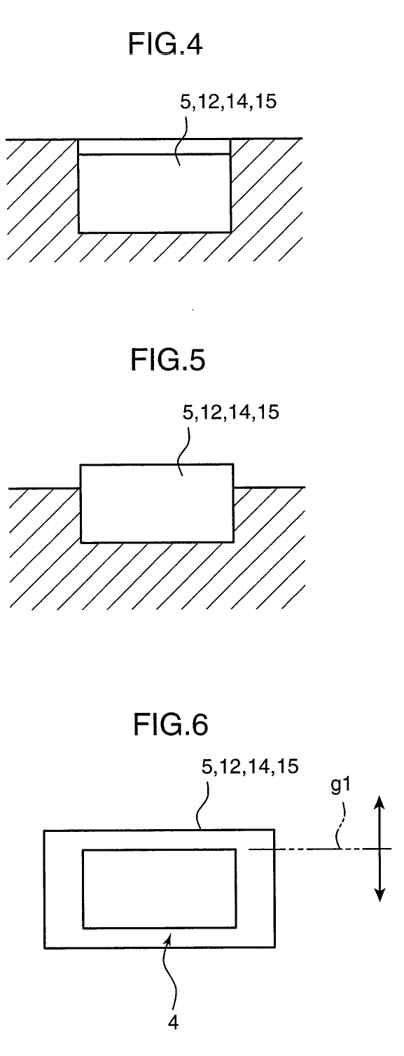

Specifically, the “buried state in the ground” includes a state where the upper surface of the housing 5 is arranged below the ground surface as shown in FIG. 4, a state where the upper surface of the housing 5 is not covered by earth and a state where an upper part of the housing 5 is exposed at the ground surface as shown in FIG. 5. Here, a permissible degree of exposure of the upper part of the housing 5 at the ground surface is based on the premise that the upper surface of the storage battery 4 is at the same height as or lower than a ground surface g1 as shown in FIG. 6. This point similarly applies in the following embodiments.

The first embodiment is characterized in that the positive electrode terminal 7 is maintained at a potential higher than a ground surface potential and the negative electrode terminal 8 is maintained at a potential lower than the ground surface potential.

Specifically, in an example shown in FIG. 2, the negative electrode terminal 8 is maintained at the potential lower than the ground surface potential by grounding the positive electrode terminal 7. Accordingly, the corrosion of the negative electrode terminal 8 can be suppressed (i.e. cathodic protection is possible) by reducing the potential of the negative electrode terminal 8 below an equilibrium potential at which metal used for the negative electrode terminal 8 is ionized (corroded). Such a mode is particularly effective when a material such as iron for which anodic protection is difficult (it is difficult to produce dense corrosion products) is used for the negative electrode terminal 8.

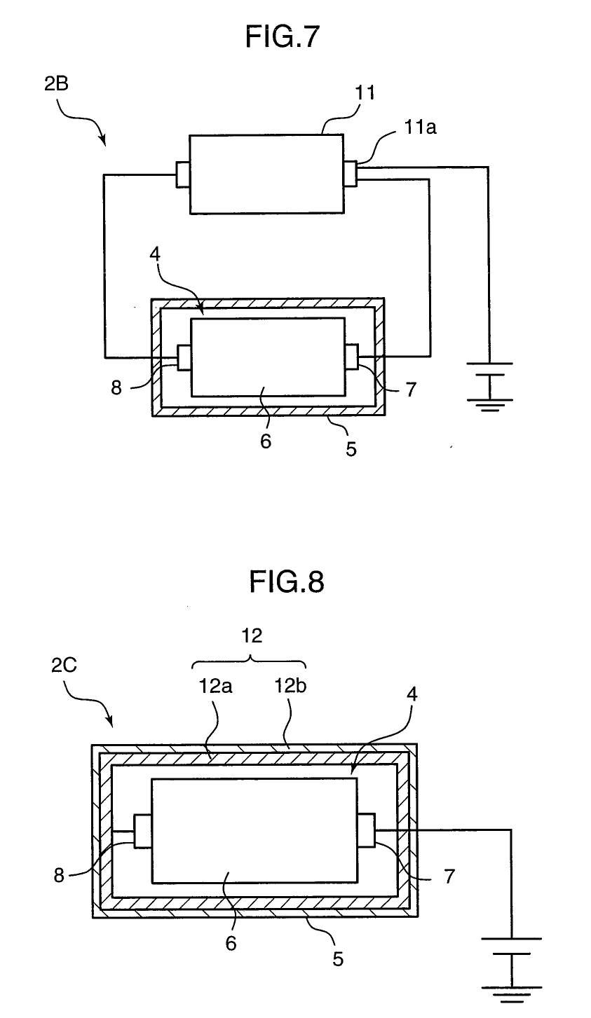

FIG. 7 is a schematic diagram showing a modification of the electricity storage device according to the first embodiment.

With reference to FIG. 7, an electricity storage device 2B is further provided with a circuit portion 11 for controlling the charge and discharge of the storage battery 4 in addition to the construction of the above electricity storage device 2A. The positive electrode terminal 7 and the negative electrode terminal 8 of the storage battery 4 are electrically connected with this circuit portion 11.

In the above electricity storage device 2B, a part of the circuit portion 11 electrically connected with the positive electrode terminal 7 is grounded. Thus, the negative electrode terminal 8 is maintained at a potential lower than the ground surface potential. Therefore, the corrosion of the negative electrode terminal 8 can be suppressed.

Normally, metal cans are often used as casings 10 of storage batteries 4 (e.g. alkaline storage batteries such as nickel-hydrogen storage batteries and nickel-cadmium storage batteries, and lithium secondary batteries such as lithium ion secondary batteries and lithium polymer secondary batteries) except lead storage batteries. Accordingly, in the case of making the casing 10 of a metal, the cathodic protection of the casing 10 can be designed by electrically connecting the casing 10 and the negative electrode terminal 8.

FIG. 8 is a schematic diagram showing a modification of the electricity storage device according to the first embodiment.

With reference to FIG. 8, an electricity storage device 2C is provided with a housing 12 unlike the above respective electricity storage devices 2A, 2B. Specifically, the housing 12 includes a metallic box body 12a and a coating film 12b covering the outer side of the box body 12a. This coating film 12b is made of an insulating material.

In the above electricity storage device 2C, the box body 12a of the housing 12 is electrically connected with the negative electrode terminal 8. By electrically connecting the box body 12a of the housing 12 and the negative electrode terminal 8 in this way, cathodic protection can also be designed for the housing 12. The coating film 12b is provided to prevent the box body 12a from being grounded in the case of being buried in the ground.

Here, in the case of electrically connecting the casing 10 (see FIG. 3) of the storage battery 4 and the negative electrode terminal 8 as described above, cathodic protection can be designed not only for the box body 12a, but also for the casing 10 by electrically connecting the box body 12a of the housing 12 and the casing 10.

### Second Embodiment

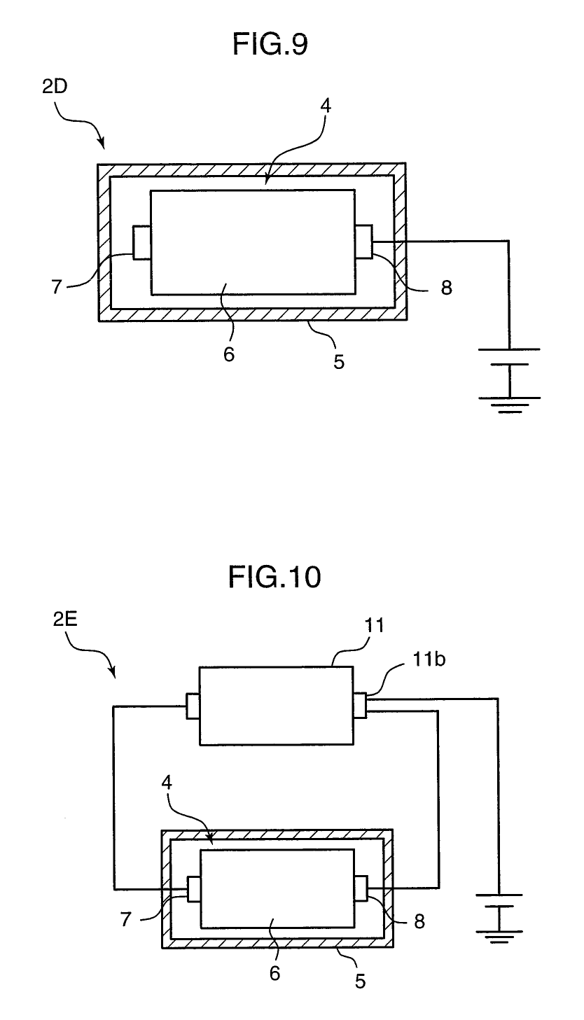

FIG. 9 is a side view in section showing an electricity storage device 2D according to a second embodiment. Points of difference from the first embodiment are mainly described below.

Unlike the electricity storage device 2A according to the first embodiment, a negative electrode terminal 8 is grounded in the electricity storage device 2D. Thus, a positive electrode terminal 7 is maintained at a potential higher than the ground surface potential.

In the electricity storage device 2D, by grounding the negative electrode terminal 8 and maintaining the positive electrode terminal 7 at the potential higher than the ground surface potential, the potential of the positive electrode terminal 7 is increased up to a region where corrosion products (e.g. Fe(OH)₃, etc. in the case of iron) of a metal used for the positive electrode terminal 7 can be stably present, thereby covering the surface of the positive electrode terminal 7 with dense corrosion products (so-called passivation) to hinder the progress of corrosion, i.e. to enable anodic protection of the negative electrode terminal 7. Such a mode is particularly effective when a material such as aluminum for which cathodic protection is easy (it is easy to produce dense corrosion products) is used for the positive electrode terminal 7.

FIG. 10 is a schematic diagram showing a modification of the electricity storage device according to the second embodiment. Points of difference from the first embodiment are mainly described below.

Unlike the electricity storage device 2B according to the first embodiment, a part 11b of a circuit portion 11 electrically connected with the negative electrode terminal 8 is grounded in an electricity storage device 2E. Thus, the positive electrode terminal 7 is maintained at a potential higher than the ground surface potential. Therefore, the corrosion of the positive electrode terminal 7 can be suppressed.

Normally, metal cans are often used as casings 10 of electricity storage device 4 (e.g. alkaline electricity storage device and lithium secondary batteries) except lead storage batteries. Accordingly, similar to the first embodiment, in the case of making the casing 10 of the storage battery 4 (see FIG. 3) of a metal, the anodic protection of the casing 10 can be designed also for the casing 10 by electrically connecting the casing 10 and the negative electrode terminal 8.

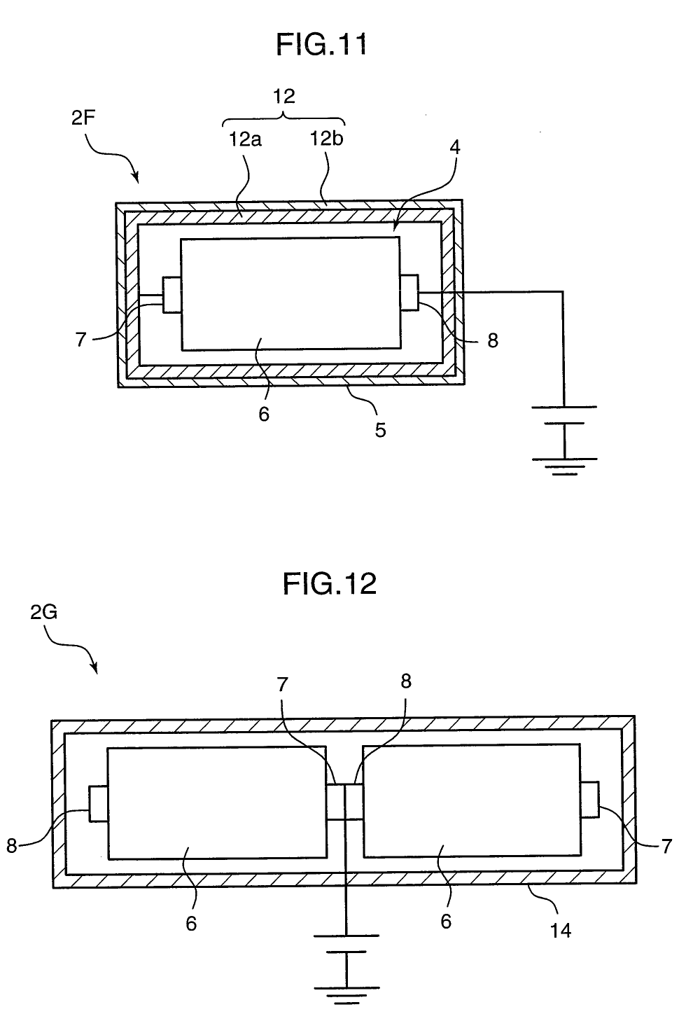

FIG. 11 is a schematic diagram showing another modification of the electricity storage device according to the second embodiment. Points of difference from the first embodiment are mainly described below.

With reference to FIG. 11, the negative electrode terminal 8 is grounded and the positive electrode terminal 7 is electrically connected with a box body 12a of a housing 12 unlike the electricity storage device 2C according to the first embodiment.

By electrically connecting the box body 12a of the housing 12 and the positive electrode terminal 7 in this way, anodic corrosion can be designed not only for the positive electrode terminal 7, but also for the housing 12. In the case of electrically connecting the metallic casing 10 of the storage battery 4 with the positive electrode terminal 7 as described above, anodic protection can be designed not only for the box body 12a, but also for the casing 10 by electrically connecting the box body 12a of the housing 12 with the casing 10.

In the above first and second embodiments, the area of the terminal maintained at the potential higher or lower than the ground surface potential is preferably set larger than that of the other terminal. In other words, the area of the negative electrode terminal 8 is preferably larger than that of the positive electrode terminal 7 in the first embodiment and the area of the positive electrode terminal 7 is preferably larger than that of the negative electrode terminal 8 in the second embodiment. This reason for this is as follows.

In the case of designing cathodic protection or anodic protection for one of the positive and negative terminals, the other terminal is grounded and no corrosion protecting mechanism can be provided therefor. Accordingly, an area to be corroded can be suppressed by minimizing the area of this terminal.

Although the circuit portion 11 is arranged outside the housing 5 in the above embodiment, it is also possible to accommodate the circuit portion 11 in the housing 5. Since the storage battery 4 and the circuit portion 11 can be handled as an integral unit by accommodating the circuit portion including an external power supply in the housing, usability is improved. In addition, corrosion protection can be designed also for a part of the circuit portion 11 accommodated in the housing 5 against water drops condensed in the housing 5.

### Third Embodiment

FIG. 12 is a side view in section showing an electricity storage device 2G according to a third embodiment.

With reference to FIG. 12, the electricity storage device 2G is provided with a pair of storage batteries 4 connected in series with each other and a housing 14 to be buried while accommodating the storage batteries 4. Since the construction of the storage batteries 4 is similar to the above embodiments, it is not described.

The housing 14 is a rectangular hollow container having such a length as to be able to accommodate the respective storage batteries 4 connected in series.

In this electricity storage device 2G, connected parts of adjacent positive and negative terminals 7, 8 of the respective storage batteries 4 are grounded, whereby the positive electrode terminal 7 of one (right) storage battery 4 is maintained at a potential higher than a ground surface potential and the negative electrode terminal 8 of the other (left) storage battery 4 is maintained at a potential lower than the ground surface potential.

By grounding the connected parts of the positive and negative terminals 7 and 8 of the electricity storage device 4 connected in series in this way, there is an advantage of being able to protect the positive electrode terminal 7 (and a part electrically connected with the positive electrode terminal 7) of the one storage battery 4 from anodic corrosion and protect the negative electrode terminal 8 (and a part electrically connected with the negative electrode terminal 8) of the other storage battery 4 from cathodic corrosion.

### Fourth Embodiment

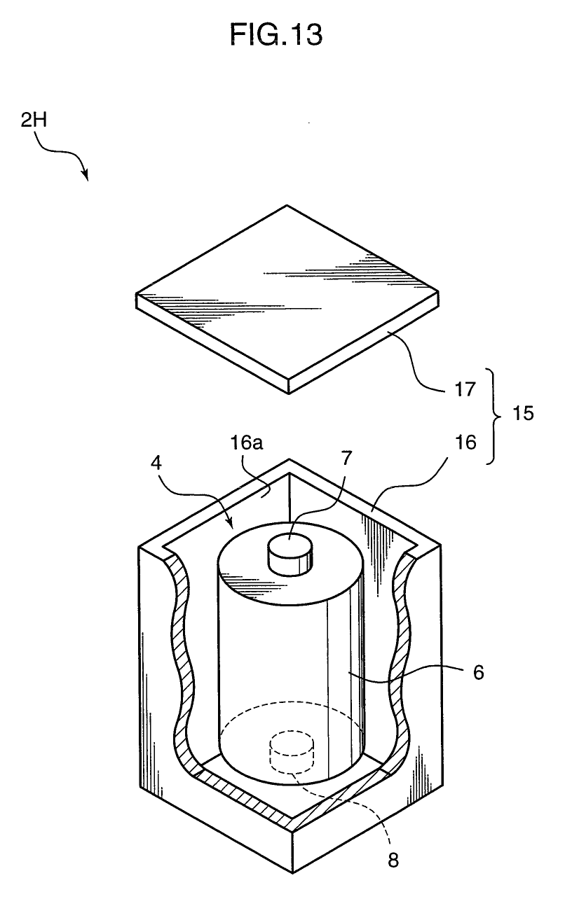

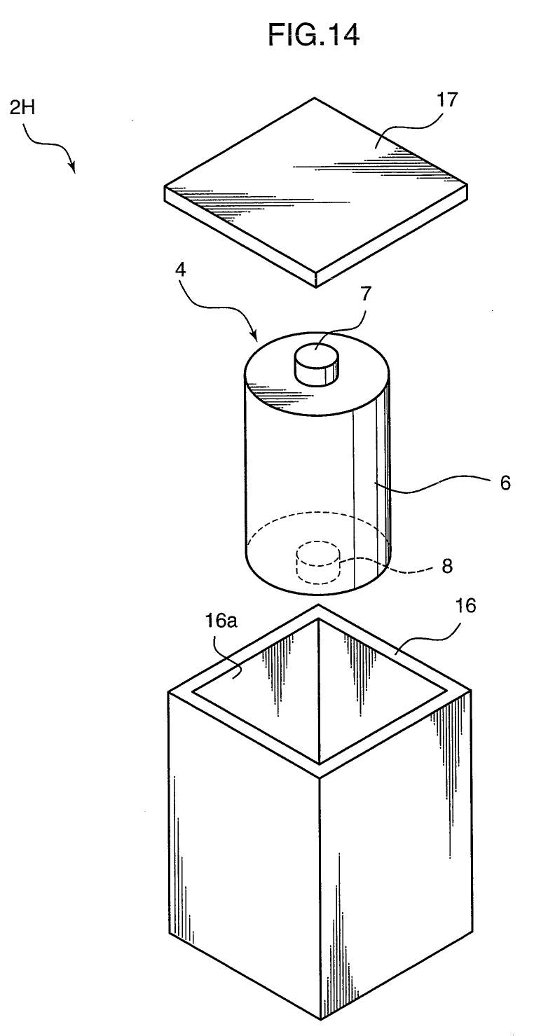

FIG. 13 is a perspective view, partly cut away, showing an electricity storage device 2H according to a fourth embodiment, and FIG. 14 is an exploded perspective view of the electricity storage device 2H of FIG. 13.

With reference to FIGS. 13 and 14, the electricity storage device 2H is provided with the storage battery 4 and a housing 15 for accommodating this storage battery 4. Since the construction of the storage battery 4 is similar to the above embodiments, it is not described.

The housing 15 is formed by combining an accommodation box 16 and a lid 17. The accommodation box 16 is a substantially rectangular bottomed container having a depth equal to or larger than a longitudinal direction of the storage battery 4, i.e. a dimension from an end surface of the positive electrode terminal 7 to an end surface of the negative electrode terminal 8 (vertical dimension in FIGS. 13 and 14). Accordingly, the storage battery 4 can be vertically inserted into the accommodation box 16 with the positive electrode terminal 7 or the negative electrode terminal 8 faced downward (negative terminal 8 is faced downward in the shown example).

The lid 17 is detachably attachable to the accommodation box 16 so as to establish a state where the lid 17 is mounted on the accommodation box 16 to cover an opening 16a of the accommodation box 16 and a state where the storage battery 4 is exposed via the opening 16a. Specifically, the lid 17 can be attached to and detached from the accommodation box 16 in a state where the housing 15 is buried such that the upper surface of the housing 15 is exposed at the ground surface as shown in FIGS. 4 and 5. Therefore, maintenance for the storage battery 4 can be performed by detaching the lid 17 from the accommodation box 16.

Although the lid 17 is described to be detachably attachable to the accommodation box 16, it is also possible to employ a lid rotatably attached to the accommodation box 16 to open and close the opening 16a.

Since the inner volume of the accommodation box 16 is normally larger than the volume of the storage battery 4 to be accommodated like the above-mentioned housing 15, a clearance is formed in the housing 15. Moisture sealed in this clearance is cooled by the inner wall of the housing 15 to condense after being warmed by the surface of the heat generating storage battery 4 particularly in winter. Here, if the storage battery 4 is randomly arranged in the housing 15, condensed water drops deposit on the positive and negative electrode terminals 7, 8 to corrode the positive and negative electrode terminals 7, 8 depending on conditions, thereby reducing the functions of the storage battery 4. Accordingly, in the electricity storage device 2H, the storage battery 4 is accommodated in the housing 15 with the negative electrode terminal 8 faced downward.

Specifically, condensed water drops naturally drop to the bottom surface of the housing 15 while avoiding the negative electrode terminal 8 (directly drop from the side surface of the storage battery 4 to the bottom surface of the housing 15) by accommodating the storage battery 4 with the negative electrode terminal 8 faced downward. Since the dropped water drops return to water vapor by a daytime variation and a seasonal variation, they do not corrode the negative electrode terminal 8. Particularly, in the case of combination with the first to third embodiments, corrosion protection can be reliably designed by facing the grounded terminal (not corroded) downward.

Although the accommodated state with the negative electrode terminal 8 faced downward is shown in FIGS. 13 and 14, the above effect can be obtained also in the case of accommodation with the positive electrode terminal 7 faced downward.

The positive and negative electrode terminals 7, 8 may be connected with a circuit portion (not shown) for controlling charge and discharge by wirings (not shown). Here, the circuit portion may be accommodated in the housing 15 or may be arranged outside the housing 15.

In the electricity storage device 2H, it is preferable to define a space between the bottom end of the downward facing positive terminal 7 or negative terminal 8 and the bottom surface of the housing 15. In the case of the example shown in FIGS. 13 and 14, the contact of water drops dropped and staying on the bottom surface of the housing 15 with the negative electrode terminal 8 can be suppressed by defining a space between the bottom end of the negative electrode terminal 8 and the bottom surface of the housing 15. Accordingly, even if the electricity storage device 2H is buried during a high humidity period (e.g. rainy season) and a large quantity of moisture is included in the housing 15, a problem caused by the corrosion of the positive electrode terminal 7 or the negative electrode terminal 8 can be suppressed.

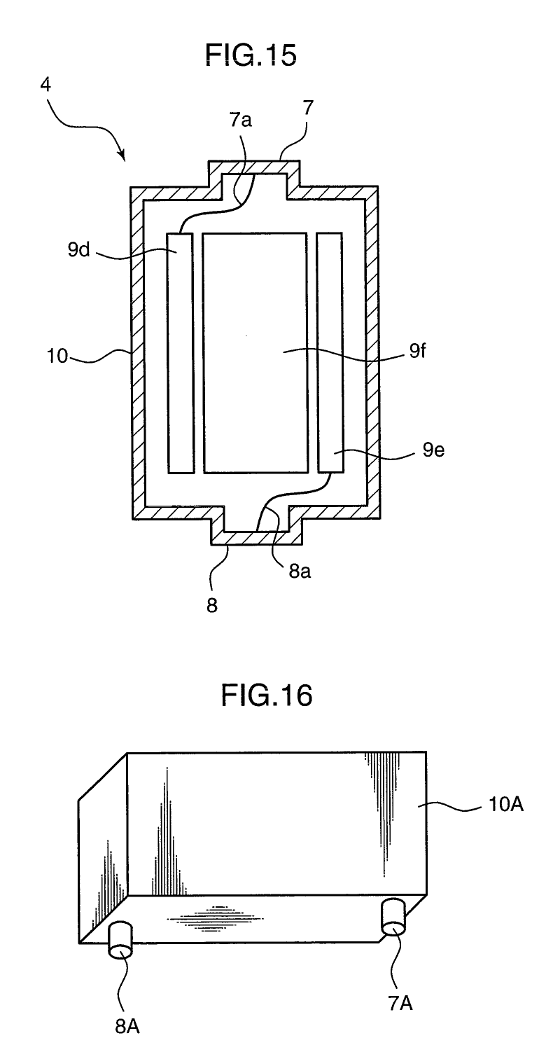

A storage battery as shown in FIG. 15 is, for example, cited as the storage battery 4 arranged with the positive electrode terminal 7 or the negative electrode terminal 8 faced downward as described above.

The storage battery 4 shown in FIG. 15 includes a positive electrode 9d connected with a positive electrode terminal 7 via a lead 7a, a negative electrode 9e connected with a negative electrode terminal 8 via a lead 8a and a separation layer (separator) 9f interposed between these positive and negative electrodes 9d, 9e.

In this storage battery 4, the separation layer 9f has a function of retaining an electrolyte. In other words, the electrolyte is impregnated in the separation layer 9f. Accordingly, a problem of leakage of the electrolyte can be avoided regardless of whether the positive electrode terminal 7 or the negative electrode terminal 8 is faced downward.

Here, a control valve type lead storage battery is, for example, cited as the storage battery 4 provided with the function of retaining the electrolyte. Unlike a wet lead storage battery generally used as a cell starter of an automotive vehicle, the control valve type lead storage battery uses a nonwoven fabric as a separator interposed between positive and negative electrodes, and this nonwoven fabric can retain a sulfuric acid as an electrolyte. Further, since a casing 10 of the control valve lead storage battery is made of a resin, it is not necessary to protect this casing 10 from corrosion, which leads to high convenience.

Although the storage battery having the positive electrode terminal 7 provided on one end surface of the casing 10 and the negative electrode terminal 8 provided on the other end surface is shown in FIG. 15, it is also possible to employ a storage battery having both a positive electrode terminal 7A and a negative electrode terminal 8A provided on one end surface of a casing 10A as shown in FIG. 16. By employing the separation layer 9f (see FIG. 15) having the function of retaining the electrolyte in this storage battery, problems such as the leakage of the electrolyte can be avoided even if the storage battery is inverted with both positive and negative electrode terminals 7, 8 faced downward as shown in FIG. 16.

### Fifth Embodiment

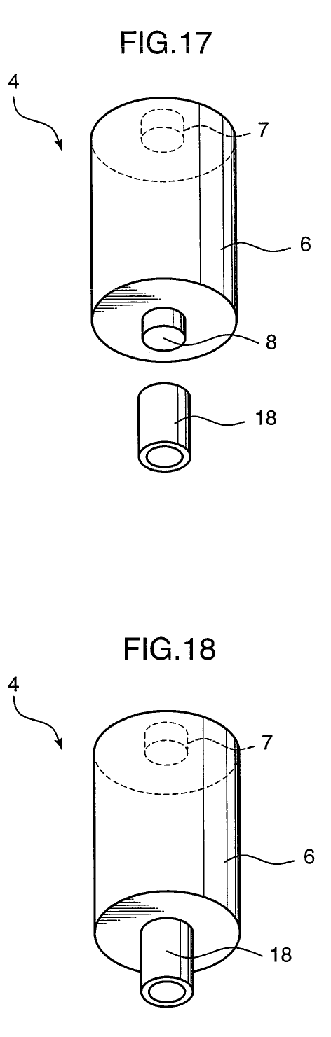

FIG. 17 is a perspective view enlargedly showing a storage battery 4 of an electricity storage device according to a fifth embodiment, and FIG. 18 is a perspective view showing a state where an enclosing member 18 is mounted on the storage battery of FIG. 17. Since the construction other than the enclosing member 18 is similar to the fourth embodiment, it is neither shown nor described.

With reference to FIGS. 17 and 18, the enclosing member (enclosing portion) 18 has such a cylindrical shape as to be able to cover a negative electrode terminal 8 of a storage battery 4. Specifically, the enclosing member 18 has an inner diameter capable of enclosing the negative electrode terminal 8, an outer diameter smaller than the diameter of a battery main body 6 of the storage battery 4 and a length longer than a projecting distance of the negative electrode terminal 8.

If the negative electrode terminal 8 is inserted into the enclosing member 18 up to the base end thereof and the enclosing member 18 is fixed to the battery main body 6 in this state, the bottom end surface of the enclosing member 18 is located below that of the negative electrode terminal 8 and the enclosing member 18 is mounted on the storage battery 4 while being hidden below the battery main body 6 of the storage battery 4. The enclosing member 18 can be fixed to the battery main body 6 using an adhesive, an adhesive tape or the like, and the negative electrode terminal 8 can be pressed into the enclosing member 18 if the inner diameter of the enclosing member 18 is adjusted.

As described above, in the fifth embodiment, the negative electrode terminal 8 is enclosed by the enclosing member 18 extending in parallel with a projecting direction of the downward facing negative electrode terminal 8. Since the negative electrode terminal 8 is enclosed in this way, the deposition of water drops on the negative electrode terminal 8 can be avoided even if the water drops run down on the side surface of the storage battery 4. Further, since the length of the downward extending enclosing member 18 is longer than the projecting distance of the negative electrode terminal 8, a space can be defined between the bottom end surface of the negative electrode terminal 8 and the bottom surface of an accommodation box 16, wherefore the effect of the fourth embodiment can be easily obtained. Specifically, in this embodiment, the space is inevitably defined between the bottom end surface of the negative electrode terminal 8 and the bottom surface of the accommodation box 16 while heat is transferred from the enclosing member 18 to the accommodation box 16 by bringing the bottom end surface of the enclosing member 18 into contact with the bottom surface of the accommodation box 16 (placing the enclosing member 18 on the bottom surface of the accommodation box 16). Therefore, both the heat radiation of the storage battery 4 and the suppression of the corrosion of the negative electrode terminal 8 can be realized.

It is preferable to fix the enclosing member 18 and the battery main body 6 with the upper end surface of the enclosing member 18 and the bottom end surface of the battery main body 6 held in close contact. By doing so, the entrance of water drops through a clearance between the enclosing member 18 and the battery main body 6 can be suppressed.

It is also possible to set the inner diameter of the enclosing member 18 larger than the outer diameter of the negative electrode terminal 8 so that a clearance can be defined between the side surface of the negative electrode terminal 8 and the inner side surface of the enclosing member 18. By doing so, even if a water drop running from the outer side surface of the enclosing member 18 to the lower surface thereof enter the interior of the enclosing member 18, the contact of the water drop with the negative electrode terminal 8 can be suppressed by the clearance between the enclosing member 18 and the negative electrode terminal 8.

If the bottom end surface of the enclosing member 18 is open as shown in FIGS. 17 and 18, the following advantage is achieved.

In the case of burying the electricity storage device 2 in an atmosphere with relatively high temperature, condensation is likely to occur in the housing 5. If the bottom end surface of the enclosing member 18 is closed in such an environment, water drops produced in the enclosing member 18 are likely to touch the negative electrode terminal 8. However, if the bottom end surface of the enclosing member 18 is open, the water drops in the enclosing member 18 can be permitted to escape to the outside through this opening. Therefore, the contact of the water drops and the negative electrode terminal 8 can be avoided.

On the contrary, the enclosing member 18 may have a closed bottom end surface, i.e. may be in the form of a bottomed container. In this case, the following advantage is achieved.

In the case of burying the electricity storage device 2 in an atmosphere with relatively low temperature, condensation is unlikely to occur in the housing 5. By closing the bottom end surface of the enclosing member 18 in such an atmosphere, even a slight possibility that water drops collected on the bottom surface of the housing 5 touch the negative electrode terminal 8 can be eliminated even if the bottom end of the bottomed can 10a comes into contact with the bottom surface of the housing 5, for example, due to an earthquake or the like.

Although only the negative electrode terminal 8 is enclosed by the enclosing member 18 in FIGS. 17 and 18, it goes without saying that similar effects can be obtained also when only the positive electrode terminal 7 is enclosed by the enclosing member 18 or both the positive electrode terminal 7 and the negative electrode terminal 8 are enclosed by the enclosing members 18. The material of the enclosing member 18 is not particularly limited, but preferably an organic or inorganic oxide such as a resin rather than a metal in terms of avoiding corrosion.

Preferably, at least the outer side surface of the enclosing member 18 is made of a water repellent material. By doing so, water drops guided to the enclosing member 18 can be reliably dropped to the bottom surface of the accommodation box 16.

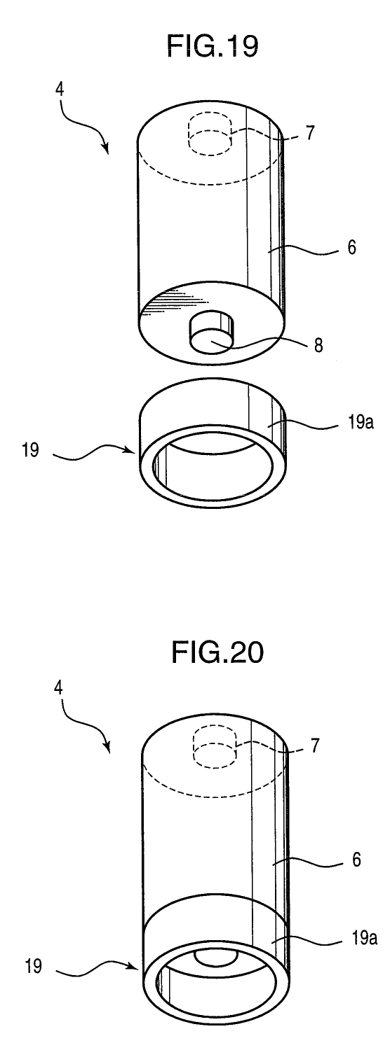

FIG. 19 is a perspective view showing a modification of the storage battery according to the fifth embodiment, and FIG. 20 is a perspective view showing a state where an enclosing member 19 is mounted on the storage battery of FIG. 19. Constructions different from those shown in FIGS. 17 and 18 are mainly described below.

The enclosing member 19 is formed to have a tubular shape having a side wall 19a arranged to extend the side surface of the storage battery 4 (battery main body 6) downward. Specifically, the outer diameter of the enclosing member 19 is substantially equal to that of the storage battery 4.

In the case of mounting such an enclosing member 19 on the storage battery 4 later on as shown, it can be mounted on the bottom surface of the battery main body 6 of the storage battery 4 using an adhesive, a tape or the like. On the other hand, in the case of providing the enclosing member 19 as a part of the battery main body 6, it can be easily formed by extending an armoring film fitted on the storage battery 4.

Although the negative electrode terminal 8 is enclosed by the enclosing member 19 in FIGS. 19 and 20, it goes without saying that similar effects can be obtained also when only the positive electrode terminal 7 is enclosed by the enclosing member 19 or both the positive electrode terminal 7 and the negative electrode terminal 8 are enclosed by the enclosing members 19.

The material of the enclosing member 19 is not particularly limited, but more preferably an organic or inorganic oxide such as a resin rather than a metal in terms of avoiding corrosion.

In the case of employing a lithium secondary battery as the storage battery 4, aluminum that easily produces dense corrosion products (high corrosion resistance) is often used as the positive electrode terminal 7 and a member electrically connected with the positive electrode terminal 7 in the lithium secondary battery. Accordingly, in the case of using the lithium secondary battery as the storage battery 4 in this way, the negative electrode terminal 8 having no function of protecting itself from corrosion is faced downward to preferentially avoid the deposition of water drops on the negative electrode terminal 8 by employing the construction in which the negative electrode terminal 8 is faced downward as in the fourth and fifth embodiments.

### Sixth Embodiment

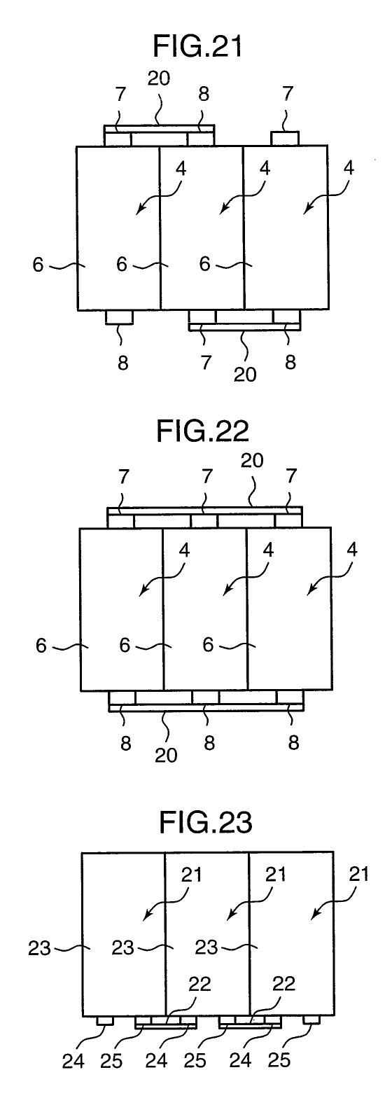

FIG. 21 is a side view enlargedly showing a storage battery 4 of an electricity storage device according to a sixth embodiment, and FIG. 22 is a side view showing a modification of the electricity storage device according to the sixth embodiment.

The electricity storage device according to the sixth embodiment is provided with three storage batteries 4, connecting members 20 for electrically connecting these storage batteries 4 with each other, and a housing (not shown) for accommodating these storage batteries 4 and connecting members 20.

The connecting members 20 are plate-like members at least the surfaces of which are made of a water repellent material. Specifically, the connecting members 20 can be formed by covering the surface of an electrically conductive metal plate with a water repellent material such as fluorocarbon. By employing such connecting members 20, it can be avoided that water drops stay on the surfaces of the connecting members 20 and water drops falling from the connecting members 20 can be reliably dropped to the bottom surface of the housing along the side surface of the storage battery 4.

In the electricity storage device shown in FIG. 21, the three storage batteries 4 are connected in series by the connecting members 20. These storage batteries 4 are accommodated in the unillustrated housing with positive electrode terminals 7 or negative electrode terminals 8 thereof faced downward. In an example shown in FIG. 21, the negative electrode terminals 8 of the left and right storage batteries 4 are faced downward and the positive electrode terminal 7 of the middle storage battery 4 is faced downward. The arrangement of the storage batteries 4 shown in FIG. 21 can also be vertically inverted.

In the electricity storage device shown in FIG. 22, the three storage batteries 4 are connected in parallel by the connecting members 20. These storage batteries 4 are accommodated in the unillustrated housing with positive electrode terminals 7 or negative electrode terminals 8 thereof faced downward. In an example shown in FIG. 22, the negative electrode terminals 8 of the respective storage batteries 4 are faced downward. The arrangement of the storage batteries 4 shown in FIG. 22 can also be vertically inverted.

In this way, the deposition of water drops on the downward facing terminals can be suppressed also in the constructions including a plurality of storage batteries 4 by arranging the positive electrode terminals 7 or the negative electrode terminals 8 to face downward. Further, by connecting a plurality of storage batteries 4 in series or in parallel, an electricity storage device having desired capacity and voltage can be constructed.

FIG. 23 is a side view showing a modification of the storage batteries of the electricity storage device according to the sixth embodiment. Constructions different from those shown in FIGS. 21 and 22 are mainly described below.

The electricity storage device according to the modification of FIG. 23 is provided with three storage batteries 21, two connecting members 22 for electrically connecting these storage batteries 21 and a housing (not shown) for accommodating these storage batteries 21 and connecting members 22.

Each storage battery 21 includes a battery main body 23, and a positive electrode terminal 24 and a negative electrode terminal 25 which are respectively provided on one end surface of the battery main body 23. The respective storage batteries 21 are accommodated in the unillustrated housing with the positive electrode terminals 24 and the negative electrode terminals 25 thereof faced downward.

Each connecting member 22 is provided between the positive electrode terminal 24 and the negative electrode terminal 25 of the adjacent storage batteries 21 to connect the respective storage batteries 21 in series. The connecting members 22 preferably have a water repellent property similar to the above connecting members 20.

By causing both the positive electrode terminals 24 and the negative electrode terminals 25 to face downward and connecting these terminals by the connecting members 22 in this way, a problem that water drops stay on the upper surfaces of the battery main bodies 23 to corrode the terminals 24, 25 can be avoided. Although the three storage batteries 21 are connected in series in FIG. 23, similar effects can be obtained even if the plurality of storage batteries 21 are connected in parallel by connecting the plurality of positive electrode terminals 24 by one connecting member 22 and connecting the plurality of negative electrode terminals 25 by one connecting member 22.

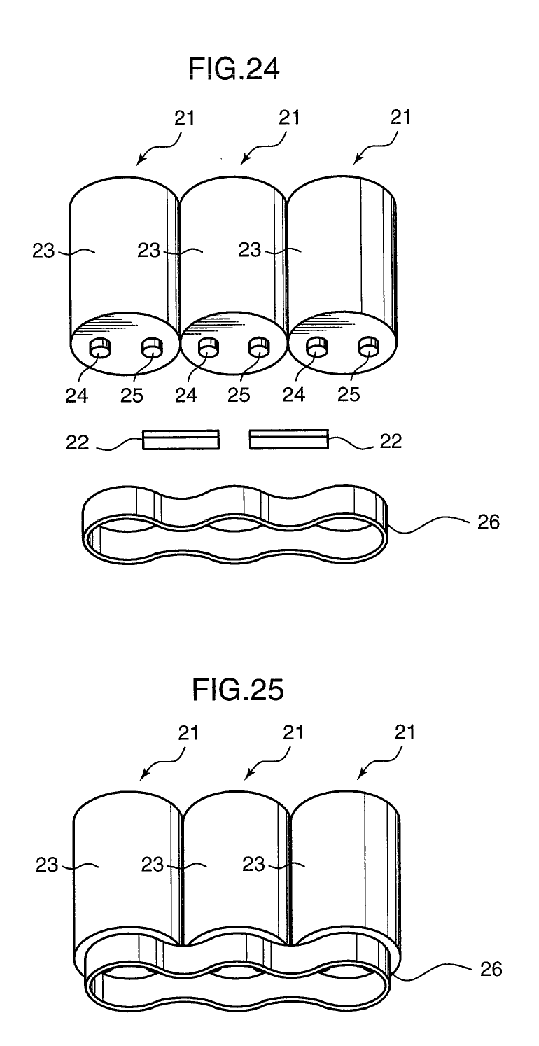

FIG. 24 is a perspective view showing a modification of the electricity storage device according to the sixth embodiment, and FIG. 25 is a perspective view showing a state where an enclosing member 26 is mounted on storage batteries of FIG. 24. Since storage batteries 21 and connecting members 22 have the same constructions as those shown in FIG. 23 described above, they are not described below.

With reference to FIGS. 24 and 25, the enclosing member 26 is a tubular member formed to have such a size capable of covering all the positive electrode terminals 24 and negative electrode terminals 25 of the respective storage batteries 21. Specifically, the enclosing member 26 is formed by connecting as many cylindrical shapes capable of collectively covering the positive electrode terminal 24 and the negative electrode terminal 25 of each storage battery 21 as the storage batteries 21 (three in a shown example). Further, the enclosing member 26 is so sized as not bulge out from the bottom surfaces of the storage batteries 21.

Although the enclosing member 26 enclosing all the positive electrode terminals 24 and negative electrode terminals 25 of the respective batteries 21 is shown in FIGS. 24 and 25, it is not necessarily limited to such a shape as to enclose all the terminals 24, 25, and may be formed to enclose at least a plurality of the respective terminals 24, 25.

In the electricity storage device shown in FIGS. 24 and 25, the positive electrode terminals 24, the negative electrode terminals 25 and the connecting members 22 are enclosed by the enclosing member 26 extending in parallel with a projecting direction of the downward facing positive electrode terminals 24 and negative electrode terminals 25. Since the respective terminals 24, 25 and the connecting members 22 are covered in this way, the deposition of water drops on the respective terminals 24, 25 and the connecting members 22 can be avoided even if the water drops run down along the side surfaces of the storage batteries 21. Further, by setting the length of the enclosing member 26 longer than the projecting distance of the respective terminals 24, 25, it is also possible to define spaces between the respective terminals 24, 25 and the bottom surface of the housing.

Although the plurality of storage batteries 21 are connected in series in FIGS. 24 and 25, it goes without saying that similar effects can be obtained even if the plurality of storage batteries 21 are connected in parallel by connecting the plurality of positive electrode terminals 24 by one connecting member 22 and connecting the plurality of negative electrode terminals 25 by one connecting member 22.

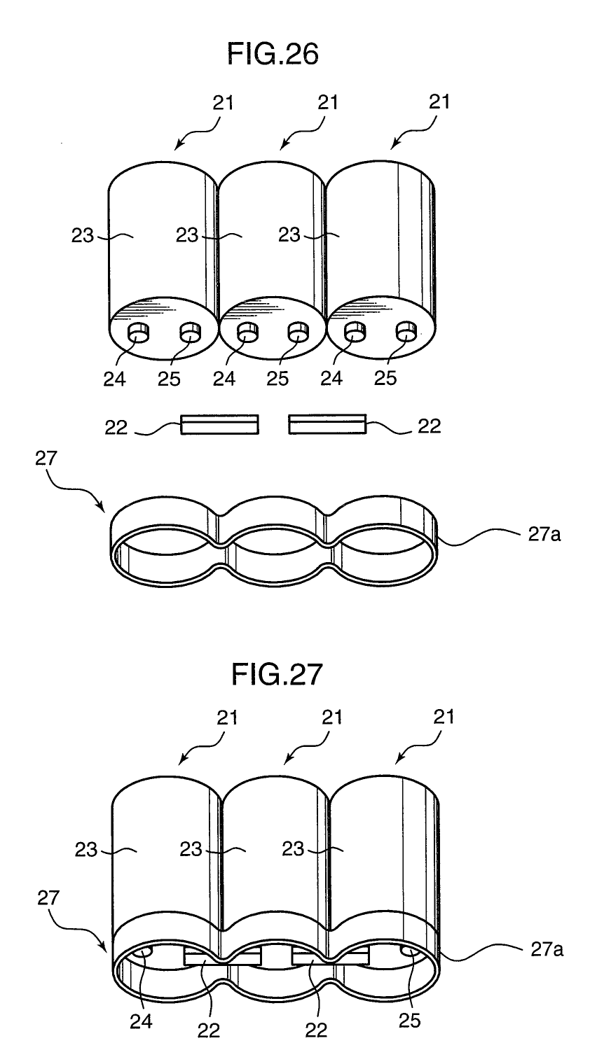

FIG. 26 is a perspective view showing a modification of the sixth embodiment, and FIG. 27 is a perspective view showing a state where an enclosing member 27 of FIG. 26 is mounted. Constructions different from those shown in FIGS. 24 and 25 are mainly described below.

The enclosing member 27 is formed to have a tubular shape having a side wall 27a arranged to extend the side surfaces of the respective storage batteries 21 (battery main bodies 23) downward while collectively enclosing the side surfaces of three storage batteries 21 (battery main bodies 23). In other words, the side wall 27a has an outer side surface substantially equivalent to a side surface obtained by connecting the side surfaces of the respective battery main bodies 23 in a state where the storage batteries 21 are held in close contact with each other.

In the case of mounting such an enclosing member 27 on the storage batteries 21 later on as shown, it can be mounted on the bottom surfaces of the battery main bodies 23 of the storage batteries 21 using an adhesive, a tape or the like. On the other hand, in the case of providing the enclosing member 27 as a part of the battery main bodies 23, it can be easily formed by extending armoring films fitted on the storage batteries 21.

Although the plurality of storage batteries 21 are connected in series in FIG. 26, it goes without saying that similar effects can be obtained also when the plurality of storage batteries 21 are connected in parallel by connecting the plurality of positive electrode terminals 24 by one connecting member 22 and connecting the plurality of negative electrode terminals 25 by one connecting member 22.

### Seventh Embodiment

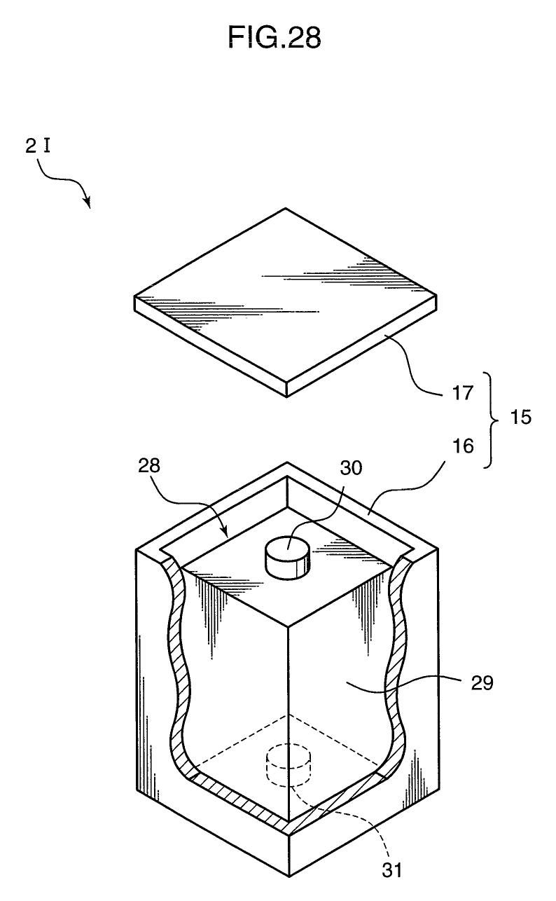

FIG. 28 is an exploded perspective view, partly cut away, showing an electricity storage device 2I according to a seventh embodiment.

The electricity storage device 2I is provided with the housing 15 and a storage battery 28 formed to have a substantially rectangular shape in conformity with a space in the housing 15.

The storage battery 28 includes a substantially rectangular battery main body 29, and a positive electrode terminal 30 and a negative electrode terminal 31 which project from the opposite longitudinal end surfaces of the battery main body 29.

According to this embodiment, the battery main body 29 is formed to have the substantially rectangular shape in conformity with the housing 15 formed to have a substantially rectangular shape in consideration of workability and easy circulation. Thus, a dead space in the housing 15 can be made smaller than in the case of accommodating the cylindrical storage battery 4 in the housing 15 as shown in FIG. 13. Therefore, according to this embodiment, the accommodation efficiency of the storage battery 28 is improved and, consequently, the energy density of the electricity storage device 2I can be increased.

Preferably, each of the storage batteries 4, 21 and 28 according to the above respective embodiments is provided with a power generating element 9 and a casing 10 as shown in FIG. 3 and a positive electrode 9a, a separation layer 9c and a negative electrode 9b are preferably laminated in a direction orthogonal to the vertical direction. The reason for this is as follows.

Generally, an electricity storage device is often buried in a place where a load (load to press the lid 17 in FIG. 13) is easily exerted from above such as a place below the floor of a parking lot or an entrance hall. Even in such a case, by laminating the positive electrode 9a, the separation layer 9c and the negative electrode 9b in the direction orthogonal to the vertical direction, it can be avoided that properties of the storage battery 4, 21 or 28 are impaired. In other words, if the positive electrode 9a, the separation layer 9c and the negative electrode 9b are laminated in the vertical direction, the power generating element 9 is also strongly pressed as a load from above is exerted and, hence, an electrolyte is easily squeezed out of the power generating element 9. On the other hand, by laminating the positive electrode 9a, the separation layer 9c and the negative electrode 9b in the direction orthogonal to the vertical direction, such a concern can be eliminated.

In the case where the battery main body 29 is rectangular as in the storage battery 2 shown in FIG. 28, a withstand load of the storage battery itself is smaller as in the case where the battery main bodies 6, 23 are cylindrical as in the storage batteries 4 and 21 shown in FIGS. 13 and 24. Thus, it is particularly preferable for the rectangular storage battery 29 to employ the construction for laminating the positive electrode 9a, the separation layer 9c and the negative electrode 9b in the direction orthogonal to the vertical direction. By doing so, the above effects become more profound.

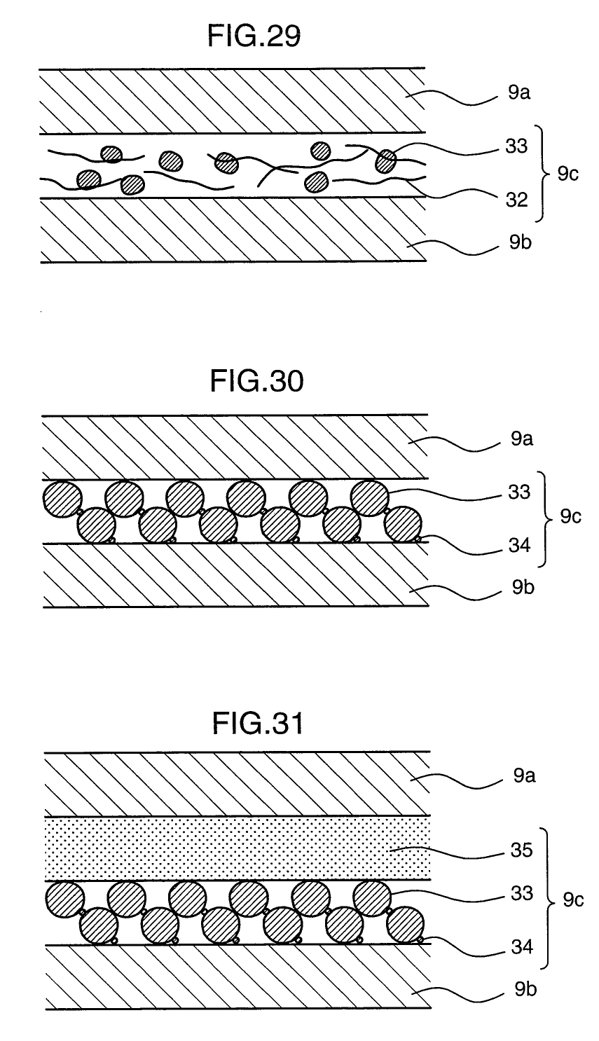

FIG. 29 is a diagrammatic section showing a specific construction of the separation layer 9c shown in FIG. 3.

With reference to FIG. 29, the separation layer 9c includes resin fibers 32 and fillers 33 made of an inorganic substance and held between the resin fibers 32. Oxides and nitrides of various metals and semi-metals can be used as the inorganic substance as the material of the fillers 33.

Reasons why the use of such a separation layer 9c is preferable are described below.

As described above, in the case of accommodating the storage battery 4, 21 or 28 in the housing 5, 12, 14 or 15, the power generating element 9 is relatively strongly pressed against the side surface of the housing 5, 12, 14 or 15 via the side surface of the storage battery 4, 21 or 28 upon being expanded at the time of charging. Since the shape change of the housing is hardly permissible in the electricity storage device used by being buried, the thickness of the separation layer decreases and the impregnated electrolyte is more likely to be squeezed out by the above pressing in the case of using the separation layer made of a microporous resin film or nonwoven fabric. Accordingly, by containing the fillers 33 made of the inorganic substance between the positive electrode 9a and the negative electrode 9b as described above, the thickness of the separation layer 9c is kept constant and the electrolyte can be held impregnated. Therefore, properties of the storage battery 4, 21 or 28 can be stabilized.

Although the fillers 33 are held in clearances between the resin fibers 32 in FIG. 29, a construction as shown in FIG. 30 can also be employed. FIG. 30 is a diagrammatic section showing a specific construction of the separation layer 9c shown in FIG. 3.

With reference to FIG. 30, the separation layer 9c includes the fillers 33 and binders 34. The binders 34 bond not only the fillers 33, but also at least either the fillers 33 and the positive electrode 9a or the fillers 33 and the negative electrode 9b. By doing so, the separation layer 9c can be easily and precisely provided on the surface of at least one of the positive electrode 9a and the negative electrode 9b by a dry application method.

Here, if the storage battery 4, 21 or 28 is a lithium secondary battery, a resin material capable of enduring a high positive electrode potential (near 4 V), for example, a fluoride such as a polyvinylidene fluoride or a polyacrylic acid can be suitably selected as the binders 34.

If the storage battery 4, 21 or 28 is an alkaline storage battery such as nickel-hydrogen storage battery or nickel-cadmium storage battery, a resin material capable of enduring a strong alkaline electrolyte such as a styrene-butadiene copolymer can be suitably selected as the binders 34.

FIG. 31 is a diagrammatic section showing a specific construction of the separation layer 9c shown in FIG. 3.

The separation layer 9c shown in FIG. 31 includes a microporous resin film 35 in addition to the above fillers 33 and binders 34 shown in FIG. 30. A drawn polyolefin (polyethylene or polypropylene) film having a thickness of about 10 to 100 μm can be used as the microporous resin film 35.

If the construction shown in FIG. 31 is employed, the electrolyte can be retained in the microporous resin film 35 having a high liquid retaining property except when the separation layer 9c is strongly pressed. Thus, properties of the storage battery 4, 21, or 28 become more stable. Particularly, if the storage battery 4, 21 or 28 is a lithium secondary battery, the electrolyte can be effectively retained even upon the expansion at the time of charging by using the microporous resin film 35 in addition to the mode shown in FIG. 30 (layer made up of the fillers 33 and the binders 34).

A void ratio of the separation layer 9c is preferably set to 40 to 65%. If the void ratio of the separation layer 9c mainly made of the fillers 33 falls below 40%, the properties of the storage battery 4, 21 or 28 drastically decrease due to a reduction in the amount of the retainable electrolyte. On the other hand, if the void ratio of this separation layer 9c exceeds 65%, the separation layer 9c becomes mechanically fragile, wherefore a problem of lacking the separation layer 9c upon forming the power generating element 9 is more likely to occur.

Since the void ratio of the microporous resin film 35 is substantially equal to a preferable range (40% to 65%) of the void ratio of the separation layer 9c, the preferable range does not substantially change even in the case of forming the separation layer 9c additionally using the microporous resin film 35 as shown in FIG. 31.

Here, if it is assumed that A denotes an ideal volume (volume on the premise that there are no voids at all) obtained from the specific gravity of the material of the separation layer 9c and B denotes an actual volume of the separation layer 9c, the void ratio of the separation layer 9c can be expressed in percentage by multiplying (B−A)/B by 100.

By assuming that an average particle diameter of the fillers 33 is 0.05 to 1 μm and an occupancy ratio of solids (volume ratio of the fillers 33 excluding the binders 34 and the like in solids) is set to 1 to 10%, the void ratio of the separation layer 9c can be easily adjusted to 40 to 65%.

An oxide of a typical metal can also be used as the fillers 33. Since the oxide of the typical metal is unlikely to undergo a chemical change, it is preferable in terms of being unlikely to cause a side reaction even in the case of a high potential as in the lithium secondary battery or in the case of exposure to an highly alkaline electrolyte as in the alkaline storage battery.

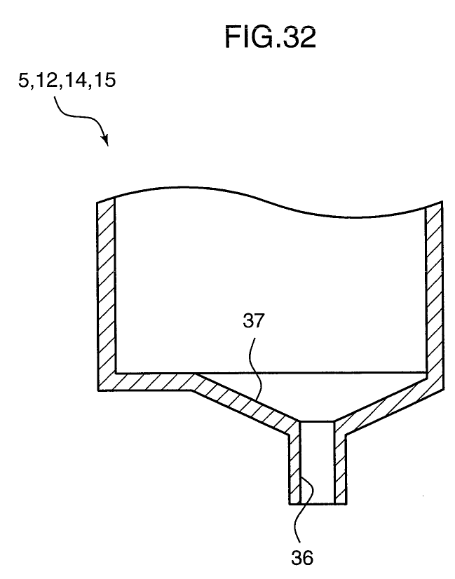

FIG. 32 is a partial diagrammatic section showing a modification of the housing in each embodiment.

With reference to FIG. 32, the housing 5, 12, 14 or 15 is preferably provided with a drainage portion 36 vertically penetrating a bottom part of the housing and an inclined portion 37 inclined downward toward the drainage portion 36.

By providing the draining portion 36 at the bottom surface of the housing 5, 12, 14 or 15, the contact of water drops collected on the bottom surface of the housing 5, 12, 14 or 15 with the projecting ends of the downward facing positive electrode terminal 7, 24 or 30 and negative electrode terminal 8, 25 or 31 can be avoided. By providing the inclining portion 37 from the bottom surface of the housing 5, 12, 14 or 15 to the drainage portion 36, water drops collected on the bottom surface of the housing 5, 12, 14 or 15 can be smoothly guided to the drainage portion 36.

The drainage portion 36 may include a valve or the like so as to be able to artificially drain water upon doing maintenance for the electricity storage device of the present invention or may be open so as to be able to constantly drain water.

Although the inclined portion 37 is provided in a part of the bottom part of the housing 5, 12, 14 or 15 in FIG. 32, the entire bottom part of the housing 5, 12, 14 or 15 may be formed into an inclined portion inclined downward to the drainage portion 36.

In the above respective embodiments, the storage battery 4, 21 or 28 may be a lithium secondary battery. This is because an electricity storage device with a higher capacity can be constructed since a lithium secondary battery such as a lithium ion secondary battery or a lithium polymer secondary battery has a high energy density.

The above specific embodiments mainly embrace inventions having the following constructions.

In order to solve the above problems, an electricity storage device according to the present invention comprises a storage battery including a positive electrode terminal and a negative electrode terminal; and a housing which accommodates the storage battery and can be buried in the ground; wherein at least one of the positive electrode terminal and the negative electrode terminal is arranged to face downward.

According to the present invention, the storage battery is accommodated with at least one of the positive electrode terminal and the negative electrode terminal (preferably a more easily corrosive one in the case of arranging only one terminal to face downward), whereby water drops condensed in the housing more easily naturally drop to the bottom part of the housing without touching the downward facing terminal. Since the water drops dropped to the bottom part of the housing return to initial water vapor due to a temperature or humidity variation in the housing, the corrosion of the downward facing terminal can be suppressed.

Thus, according to the present invention, the occurrence of problems resulting from condensation in the housing can be suppressed, wherefore a buriable electricity storage device with high reliability can be provided.

Another electricity storage device according to the present invention comprises a storage battery having a positive electrode terminal and a negative electrode terminal; and a housing which accommodates the storage battery and can be buried in the ground; wherein at least one of a first condition of maintaining the potential of the negative electrode terminal lower than a reference ground surface potential and a second condition of maintaining the potential of the positive electrode terminal higher than the reference ground surface potential is satisfied.

According to the present invention, the occurrence of problems resulting from condensation in the housing can be suppressed, wherefore a buriable electricity storage device with high reliability can be provided. The reason for this is as follows.

Since the positive electrode terminal and the negative electrode terminal of the electricity storage device are mainly made of metals, corrosion occurs and progresses due to the deposition of water drops. The present inventors found out the following two conditions as conditions for hindering the occurrence and progress of this corrosion.

The first condition is to maintain the negative electrode terminal at a potential lower than the ground surface potential (hereinafter, called cathodic protection). By intentionally reducing the potential of the negative electrode terminal lower than an equilibrium potential at which the metal used for the negative electrode terminal is ionized (corroded), the occurrence of corrosion is hindered to maintain a state of being a metal.

The second condition is to maintain the positive electrode terminal at a potential higher than the ground surface potential (hereinafter, called anodic protection). By increasing the potential of the positive electrode terminal up to a region where corrosion products (e.g. Fe(OH)₃ if the metal is an iron) of the metal used for the positive electrode terminal can be stably present and covering the surface with dense corrosion products (so-called passivation), the progress of the corrosion is hindered.

By applying at least one of the cathodic protection and the anodic protection, such corrosion as to impair functions can be suppressed for at least one of the positive electrode terminal and the negative electrode terminal. Thus, the occurrence of problems resulting from condensation in the housing can be suppressed, wherefore a buriable electricity storage device with high reliability can be provided.

Since the above respective inventions are designed to prevent the influence of condensation caused by heat generation of the electricity storage device, the state “buried in the ground” in the respective inventions also includes a state where condensation could occur, i.e. a state where a part of the housing is buried in the ground. Here, the state where “the part of the housing is buried in the ground” includes a state where an upper part of the housing projects from the ground surface. Specifically, even if the upper part of the housing projects from the ground surface, such a state falls within the above state where “the part of the housing is buried in the ground” provided that the housing is buried such that the upper surface of the storage battery accommodated in the housing is located at the same height position as or lower than the ground surface. By doing so, property deterioration of the storage battery is suppressed and condensation becomes more unlikely to occur to decrease a chance of corrosion itself since the storage battery is arranged in a range equal to or below the ground surface where a temperature change is relatively small.

In the above electricity storage device, at least one of the positive electrode terminal and the negative electrode terminal is preferably arranged to face downward.

By combining the above respective inventions in this way, a buriable electricity storage device with higher reliability can be provided.

In the above electricity storage device, at least one of the terminals is preferably so arranged as to define a space between the bottom end of the at least one terminal and the bottom surface of the housing.

With this construction, since the space is defined between the terminal and the bottom surface of the housing, the contact of the terminal and water drops can be avoided by this defined space even if condensed water drops are collected on the bottom surface of the housing.

In the electricity storage device, it is preferable to further comprise an enclosing portion for enclosing the at least one terminal.

With this construction, the contact of condensed water drops with the terminal can be effectively suppressed in a naturally falling process of condensed water drops by enclosing the terminal by the enclosing portion.

In the above electricity storage device, it is preferable that the at least one terminal projects downward from the bottom surface of a battery main body of the storage battery; and that the enclosing portion encloses a side surface of the at least one terminal.

With this construction, even if water drops run down on the side surface of the battery main body, they can be dropped to the bottom of the housing along the outer side surface of the enclosing portion. Thus, the contact of the water drops with the side surface of the at least one terminal can be prevented.

In the electricity storage device, at least the outer side surface of the enclosing portion is made of a water repellent material.

With this construction, water drops depositing on the outer side surface of the enclosing portion can reliably run down.

In the above electricity storage device, the enclosing portion preferably includes a side wall to be so arranged as to extend the side surface of the storage battery downward.

With this construction, it is possible not only to cause water drops running down on the side surface of the storage battery to run down along the outer side surface of the enclosing portion, but also to form such a side wall by a simple construction of extending a part of an armoring member of the storage battery.

In the above electricity storage device, the negative electrode terminal is preferably arranged to face downward.

With this construction, by preferentially protecting the negative electrode terminal from water drops over the positive electrode terminal, the corrosion of the terminals can be more reliably suppressed. In other words, since a material with higher corrosion resistance (e.g. aluminum) is used for the positive electrode terminal as compared with the negative electrode terminal, the corrosion of the electricity storage device as a whole can be suppressed by preferentially arranging the negative electrode terminal to face downward over the positive electrode terminal.

In the above electricity storage device, it is preferable that a plurality of said storage batteries are provided; that a connecting member for electrically connecting the respective batteries with each other is further provided; and that the surface of the connecting member is water repellent.

With this construction, water drops depositing on the connecting member can be actively dropped.

In the above electricity storage device, both the positive electrode terminal and the negative electrode terminal are preferably arranged to face downward.

With this construction, since it is more difficult for water drops condensed in the housing to touch both the positive electrode terminal and the negative electrode terminal in the process of naturally dropping to the bottom of the housing, the corrosion of the both terminals can be suppressed.

In the above electricity storage device, it is preferable that a plurality of said storage batteries are provided; and that a connecting member for electrically connecting the respective batteries with each other and an enclosing portion for enclosing all of the positive electrode terminals and the negative electrode terminals of the respective storage batteries and the connecting member are further provided.

With this construction, the corrosion of the both terminals of each storage battery can be effectively suppressed even upon connecting a plurality of storage batteries.

In the above electricity storage device, the enclosing portion preferably includes a side wall arranged to extend the side surfaces of the respective storage batteries downward while collectively enclosing the side surfaces of the respective storage batteries.

With this construction, water drops running down along the side surfaces of the plurality of storage batteries connected with each other are caused to run down along the side wall of the enclosing portion, whereby the contact of the water drops with the respective terminals can be effectively suppressed.

In the above electricity storage device, it is preferable that the storage battery includes a power generating element including a positive electrode and a negative electrode and a casing for accommodating the power generating element; and that the positive electrode and the negative electrode of the power generating element are laminated in a lateral direction orthogonal to a vertical direction.

With this construction, it can be suppressed that the positive electrode and the negative electrode are pressed in a lamination direction even if a large load is exerted from above. Thus, a problem that an electrolyte is squeezed out from the positive electrode and the negative electrode as they are pressed can be prevented.

In the above electricity storage device, the storage battery preferably further includes a separation layer provided between the positive electrode and the negative electrode and including fillers made of an inorganic substance.

With this construction, the electrolyte can be stably contained in the separation layer since the thickness of the separation layer can be kept constant by including the fillers.

In the above electricity storage device, the separation layer further includes binders.

With this construction, since the fillers, the fillers and the positive electrode and the fillers and the negative electrodes can be bonded by the binders, the separation layer can be easily and precisely provided on a surface of the positive electrode or the negative electrode by a dry application method.

In the electricity storage device, the separation layer preferably further includes a microporous resin film.

With this construction, properties of the storage battery can be more stabilized since the electrolyte can be retained by the microporous resin film having a high liquid retaining property.

In the above electricity storage device, a void ratio of the separation layer is preferably set to 40 to 65%.

With this construction, the quality of the storage battery can be improved. In other words, if the void ratio of the separation layer falls below 40%, functions as the storage battery become unstable due to a reduction in the amount of the electrolyte to be retained. On the other hand, if the void ratio of the separation layer exceeds 65%, the separation layer becomes mechanically fragile.

In the above electricity storage device, the fillers are preferably made of an oxide of a typical metal.

With this construction, a storage battery resistant to chemical changes can be provided by taking advantage of such a property of the oxide of the typical metal as to be unlikely to undergo chemical changes.

In the above electricity storage device, a draining portion is preferably provided at the bottom surface of the housing.

With this construction, water drops condensed and dropped in the housing can be drained through the drainage portion.

In the above electricity storage device, an inclined portion inclined downward toward the drainage portion is provided at the bottom surface of the housing.

With this construction, water drops dropped to the bottom surface of the housing can be guided to the drainage portion along the inclined portion.

In the above electricity storage device, it is preferable that a plurality of said storage batteries are provided; and a connecting member for electrically connecting the respective storage batteries with each other is further provided.

With this construction, an electricity storage device having desired capacity and voltage can be constructed by connecting the plurality of storage batteries.

In the above electricity storage device, the housing and the storage battery are preferably formed to have substantially rectangular shapes.

With this construction, since both the housing and the storage battery are formed to have substantially rectangular shapes, a dead space between the storage battery and the housing can be more reduced as compared with the case where a cylindrical storage battery is accommodated in a substantially rectangular housing. Therefore, the energy density of the entire electricity storage device can be increased.

In the above electricity storage device, the housing is preferably constructed to be buriable in the ground such that the upper surface of the housing is located at the same height position as or higher than the ground surface.

With this construction, the housing can be buried in the ground with the upper surface thereof exposed at the ground surface.

In the above electricity storage device, it is preferable that the housing includes an accommodation box having an opening for exposing the accommodated storage battery to the outside and a lid displaceably attachable to the accommodation box between a state where the opening is closed and a state where the opening is exposed; and that the accommodation box is constructed to be buriable in the ground such that the upper surface of the lid is exposed at the ground surface.

With this construction, since the lid exposed at the ground surface can be opened and closed with the accommodation box buried in the ground, maintenance can be easily done for the storage battery.

In the electricity storage device, the storage battery is preferably a lithium secondary battery.

With this construction, a high-capacity electricity storage device having a high energy density can be provided.

The storage battery may also be a lead storage battery.

In the above electricity storage device, the storage battery preferably includes a retaining member for retaining an electrolyte.

With this construction, since the electrolyte can be retained by the retaining member, even if the storage battery is, for example, so inverted that either one of the positive electrode terminal or the negative electrode terminal faces downward, a problem of leakage of the electrolyte can be avoided.

A control valve type lead storage battery can be, for example, cited as the storage battery including the retaining member. The control valve type lead storage battery uses a nonwoven fabric as a separator interposed between the positive electrode and the negative electrode unlike a wet lead storage battery generally used as a cell starter of an automotive vehicle, and this nonwoven fabric can retain a sulfuric acid as an electrolyte. Further, since the control valve type lead storage battery has a casing made of a resin, there are advantages of requiring no corrosion protection for this casing and having high convenience.

The storage battery constructed to satisfy at least one of the first and second conditions can be specifically constructed to satisfy the first condition by grounding the positive electrode terminal.

In the case of grounding the positive electrode terminal in this way, it is preferable that a circuit portion for controlling the charge and discharge of the storage battery is further provided; and that a part of the circuit portion electrically connected with the positive electrode terminal is grounded.

With this construction, the first condition can be satisfied by grounding the circuit portion.

In the above electricity storage device, it is preferable that the storage battery includes a power generating element including a positive electrode and a negative electrode and a casing for accommodating the power generating element; and that the casing is made of a metal and electrically connected with the negative electrode terminal.

With this construction, cathodic protection can be designed also for the casing made of the metal.

In the above electricity storage device, the housing is preferably made of a metal and electrically connected with the negative electrode terminal.

With this construction, cathodic protection can be designed also for the housing made of the metal.

Further, the second condition may be satisfied by grounding the negative electrode terminal.

In the case of grounding the negative electrode terminal in this way, it is preferable that a circuit portion for controlling the charge and discharge of the storage battery is further provided; and that a part of the circuit portion electrically connected with the negative electrode terminal is grounded.

With this construction, the second condition can be satisfied by grounding the circuit portion.

In the above electricity storage device, it is preferable that the storage battery includes a power generating element including a positive electrode and a negative electrode and a casing for accommodating the power generating element; and that the casing is made of a metal and electrically connected with the positive electrode terminal.

With this construction, anodic protection can be designed also for the casing made of the metal.

In the above electricity storage device, the housing is preferably made of a metal and electrically connected with the positive electrode terminal.

With this construction, anodic protection can be designed also for the housing made of the metal.

In the above electricity storage device, the area of the grounded one of the positive electrode terminal and the negative electrode terminal is preferably set smaller than that of the ungrounded one.

With this construction, the area of the one terminal for which it is difficult to design corrosion protection because of being grounded is set smaller than that of the other terminal in a construction for designing corrosion protection for the other terminal while grounding the one terminal. Therefore, an area to be corroded can be decreased.

In the above electricity storage device, it is preferable that a circuit portion for controlling the charge and discharge of the storage battery is further provided; and the circuit portion is accommodated in the housing.

With this construction, the storage battery and the circuit portion can be integrally handled via the housing, wherefore usability is improved.

In the above electricity storage device, it is preferable that a plurality of said storage batteries connected in series with each other are provided; and that the first condition is satisfied for one of the adjacent storage batteries and the second condition is satisfied for the other storage battery by grounding a connected part of the positive electrode terminal and the negative electrode terminal of the adjacent storage batteries.

With this construction, it is possible to design cathodic protection for one of the adjacent storage batteries while designing anodic protection for the other storage battery.

According to the present invention, problems resulting from condensation can be avoided in a buriable electricity storage device. Therefore, an electricity storage device, which is not only environmentally friendly, but also has high stability, can be provided.

Since the electricity storage device of the present invention is suitably used by being buried in the ground or in accommodation spaces of various buildings, it has a significant influence on the development of industries as means for storing and utilizing night power and natural energy.

This application is based on Japanese patent application No. 2008-131136 and No. 2008-131137 filed in Japan Patent Office on May 19, 2008 and No. 2009-108866 filed in Japanese Patent Office on Apr. 28, 2009, the contents of which are hereby incorporated by reference.

As this invention may be embodied in several forms without departing from the spirit of essential properties thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An electricity storage device, comprising:
a storage battery including a positive electrode terminal and a negative electrode terminal; and
a housing which accommodates the storage battery and can be buried in the ground;
wherein at least one of the positive electrode terminal and the negative electrode terminal is arranged to face downward.

2. An electricity storage device according to claim 1, wherein at least one of the terminals is so arranged as to define a space between the bottom end of the at least one terminal and the bottom surface of the housing.

3. An electricity storage device according to claim 1, further comprising an enclosing portion for enclosing the at least one terminal.

4. An electricity storage device according to claim 3, wherein:
the at least one terminal projects downward from a bottom surface of a battery main body of the storage battery; and
the enclosing portion encloses a side surface of the at least one terminal.

5. An electricity storage device according to claim 3, wherein at least an outer side surface of the enclosing portion is made of a water repellent material.

6. An electricity storage device according to claim 3, wherein the enclosing portion includes a side wall to be so arranged as to extend a side surface of the storage battery downward.

7. An electricity storage device according to claim 1, wherein the negative electrode terminal is arranged to face downward.

8. An electricity storage device according to claim 1, wherein:
a plurality of said storage batteries are provided;
the electricity storage device further comprises a connecting member for electrically connecting the respective batteries with each other; and
a surface of the connecting member is water repellent.

9. An electricity storage device according to claim 1, wherein both the positive electrode terminal and the negative electrode terminal are arranged to face downward.

10. An electricity storage device according to claim 9, wherein:
a plurality of said storage batteries are provided; and
the electricity storage device further comprises a connecting member for electrically connecting the respective batteries with each other and an enclosing portion for enclosing all of the positive electrode terminals and the negative electrode terminals of the respective storage batteries and the connecting member.

11. An electricity storage device according to claim 10, wherein the enclosing portion includes a side wall arranged to extend side surfaces of the respective storage batteries downward while collectively enclosing the side surfaces of the respective storage batteries.

12. An electricity storage device according to claim 1, wherein:
the storage battery includes a power generating element including a positive electrode and a negative electrode and a casing for accommodating the power generating element; and
the positive electrode and the negative electrode of the power generating element are laminated in a lateral direction orthogonal to a vertical direction.

13. An electricity storage device according to claim 12, wherein the storage battery further includes a separation layer provided between the positive electrode and the negative electrode and including fillers made of an inorganic substance.

14. An electricity storage device according to claim 13, wherein the separation layer further includes binders.

15. An electricity storage device according to claim 13, wherein the separation layer further includes a microporous resin film.

16. An electricity storage device according to claim 13, wherein a void ratio of the separation layer is set to 40 to 65%.

17. An electricity storage device according to claim 13, wherein the fillers are made of an oxide of a typical metal.

18. An electricity storage device, comprising:
a storage battery having a positive electrode terminal and a negative electrode terminal; and
a housing which accommodates the storage battery and can be buried in the ground;
wherein at least one of a first condition of maintaining a potential of the negative electrode terminal lower than a reference ground surface potential and a second condition of maintaining a potential of the positive electrode terminal higher than the reference ground surface potential is satisfied.

19. An electricity storage device according to claim 18, wherein the first condition is satisfied by grounding the positive electrode terminal.

20. An electricity storage device according to claim 19, further comprising a circuit portion for controlling the charge and discharge of the storage battery, wherein a part of the circuit portion electrically connected with the positive electrode terminal is grounded.

21. An electricity storage device according to claim 19, wherein:
the storage battery includes a power generating element including a positive electrode and a negative electrode and a casing for accommodating the power generating element; and
the casing is made of a metal and electrically connected with the negative electrode terminal.

22. An electricity storage device according to claim 19, wherein the housing is made of a metal and electrically connected with the negative electrode terminal.

23. An electricity storage device according to claim 18, wherein the second condition is satisfied by grounding the negative electrode terminal.

24. An electricity storage device according to claim 23, further comprising a circuit portion for controlling the charge and discharge of the storage battery, wherein a part of the circuit portion electrically connected with the negative electrode terminal is grounded.

25. An electricity storage device according to claim 23, wherein:
the storage battery includes a power generating element including a positive electrode and a negative electrode and a casing for accommodating the power generating element; and
the casing is made of a metal and electrically connected with the positive electrode terminal.

26. An electricity storage device according to claim 23, wherein the housing is made of a metal and electrically connected with the positive electrode terminal.

27. An electricity storage device according to claim 19, wherein an area of the grounded one of the positive electrode terminal and the negative electrode terminal is set smaller than that of the ungrounded one.

28. An electricity storage device according to claim 18, further comprising a circuit portion for controlling the charge and discharge of the storage battery, wherein the circuit portion is accommodated in the housing.

29. An electricity storage device according to claim 18, wherein:
a plurality of said storage batteries connected in series with each other are provided; and
the first condition is satisfied for one of the adjacent storage batteries and the second condition is satisfied for the other storage battery by grounding a connected part of the positive electrode terminal and the negative electrode terminal of the adjacent storage batteries.

30. An electricity storage device according to claim 18, wherein at least one of the positive electrode terminal and the negative electrode terminal is arranged to face downward.

31. An electricity storage device according to claim 30, wherein the at least one terminal is so arranged as to define a space between the bottom end of the at least one terminal and the bottom surface of the housing.

32. An electricity storage device according to claim 30, further comprising an enclosing portion for enclosing the at least one terminal.

33. An electricity storage device according to claim 32, wherein:
the at least one terminal projects downward from a bottom surface of a battery main body of the storage battery; and
the enclosing portion encloses a side surface of the at least one terminal.

34. An electricity storage device according to claim 32, wherein at least an outer side surface of the enclosing portion is made of a water repellent material.

35. An electricity storage device according to claim 32, wherein the enclosing portion includes a side wall to be so arranged as to extend a side surface of the storage battery downward.

36. An electricity storage device according to claim 30, wherein the negative electrode terminal is arranged to face downward.

37. An electricity storage device according to claim 30, wherein:
a plurality of said storage batteries are provided;
the electricity storage device further comprises a connecting member for electrically connecting the respective batteries with each other; and
a surface of the connecting member is water repellent.

38. An electricity storage device according to claim 30, wherein both the positive electrode terminal and the negative electrode terminal are arranged to face downward.

39. An electricity storage device according to claim 38, wherein:
a plurality of said storage batteries are provided; and
the electricity storage device further comprises a connecting member for electrically connecting the respective batteries with each other and an enclosing portion for enclosing all of the positive electrode terminals and the negative electrode terminals of the respective storage batteries and the connecting member.

40. An electricity storage device according to claim 39, wherein the enclosing portion includes a side wall arranged to extend side surfaces of the respective storage batteries downward while collectively enclosing the side surfaces of the respective storage batteries.

41. An electricity storage device according to claim 30, wherein:
the storage battery includes a power generating element including a positive electrode and a negative electrode and a casing for accommodating the power generating element; and
the positive electrode and the negative electrode of the power generating element are laminated in a lateral direction orthogonal to a vertical direction.

42. An electricity storage device according to claim 41, wherein the storage battery further includes a separation layer provided between the positive electrode and the negative electrode and including fillers made of an inorganic substance.

43. An electricity storage device according to claim 42, wherein the separation layer further includes binders.

44. An electricity storage device according to claim 42, wherein the separation layer further includes a microporous resin film.

45. An electricity storage device according to claim 42, wherein a void ratio of the separation layer is set to 40 to 65%.

46. An electricity storage device according to claim 42, wherein the fillers are made of an oxide of a typical metal.

47. An electricity storage device according to claim 1, wherein a draining portion is provided at the bottom surface of the housing.

48. An electricity storage device according to claim 47, wherein an inclined portion inclined downward toward the drainage portion is provided at the bottom surface of the housing.

49. An electricity storage device according to claim 1, wherein:
a plurality of said storage batteries are provided; and
the electricity storage device further comprises a connecting member for electrically connecting the respective storage batteries with each other.

50. An electricity storage device according to claim 1, wherein the housing and the storage battery are formed to have substantially rectangular shapes.

51. An electricity storage device according to claim 1, wherein the housing is constructed to be buriable in the ground such that the upper surface of the housing is located at the same height position as or higher than the ground surface.

52. An electricity storage device according to claim 1, wherein:
the housing includes an accommodation box having an opening for exposing the accommodated storage battery to the outside and a lid displaceably attachable to the accommodation box between a state where the opening is closed and a state where the opening is exposed; and
the accommodation box is constructed to be buriable in the ground such that the upper surface of the lid is exposed at the ground surface.

53. An electricity storage device according to claim 1, wherein the storage battery is a lithium secondary battery.

54. An electricity storage device according to claim 1, wherein the storage battery is a lead storage battery.

55. An electricity storage device according to claim 54, wherein the storage battery includes a retaining member for retaining an electrolyte.
